(19) United States
(12) Patent Application Publication
(10) Pub. No.: US 2015/0081443 A1
(43) Pub. Date: Mar. 19, 2015

(54) SYSTEM AND METHOD FOR ADVERTISING

(71) Applicant: BlackBerry Limited, Waterloo (CA)

(72) Inventors: William James Davis, Toronto (CA); Anthony Patrick Plec, Trophy Club, TX (US); Marino Cherubin, Ancaster (CA)

(21) Appl. No.: 14/030,847

(22) Filed: Sep. 18, 2013

(51) Int. Cl. G06Q 30/02

(52) U.S. Cl. CPC G06Q 30/0251
USPC 705/14.58; 705/14.49

(57) ABSTRACT

An advertisement sharing system transmits by a processor an advertisement to a first user device based on a criterion for transmitting the advertisement. A request is received from the first user device to share the advertisement with a second user device. A reference to the advertisement and/or advertisement is transmitted to the second user device. A request is received from the second user device to retrieve the advertisement related to the reference to the advertisement and/or advertisement. Whether or not to transmit the advertisement to the second user device is determined based on the request from the second user device and the criterion for transmitting the advertisement. The advertisement is transmitted to the second user device based on the determination.

### FIELD

This application relates generally to online advertising. More specifically, this application relates to the targeting of advertisements.

### BACKGROUND

Advertisements for goods and services can be sent to individuals in a variety of ways, including through the print media, over the radio and television and online. Advances in technology have allowed advertisers to employ targeting of advertisements. Sophisticated web sites track a computer user's previous browsing history to serve up advertisements that relate to the computer user's browsing history. For example, if the computer user has searched for shoes or has visited web-sites that sell shoes, a subsequent web site that the computer user visits may display an advertisement for shoes.

### BRIEF DESCRIPTION OF THE DRAWINGS

FIG. 1 is an example network in which an example advertising targeting server may operate.

FIG. 2A illustrates an example network in which advertising targeting server shares advertisements between users based on user information and advertisement targeting criterion.

FIG. 2B illustrates another example network in which advertising targeting server shares advertisements between users based on user information and advertisement targeting criterion.

FIG. 3 illustrates example user information data structures associated with users and that may be stored in a user database accessed by an advertising targeting server.

FIG. 4 illustrates example advertisement targeting criterion structures associated with advertisements and that may be stored in an advertisement database accessed by an example advertising targeting server.

FIG. 5 is a flow diagram of an example method that may be implemented in an advertising targeting server.

FIG. 6 is a block diagram of an example user equipment.

FIG. 7 is a block diagram of an example advertising targeting/application server that may share advertisements based on criterion associated with advertisements and users.

### DETAILED DESCRIPTION

Methods, systems and apparatus described herein can operate to receive a message from a sender, analyze content in the message and based on the result of the analysis transmit the message to a recipient of the message. Criterion associated with the content and information associated with the recipient are received and it is determined if information associated with the recipient complies or satisfies criterion associated with the content. In response to determining the criterion associated with the recipient complies or satisfies criterion associated with the content, the content is transmitted to the recipient.

The systems and methods may be configured to control the transmission of messages that include third-party content like advertisements. These systems and methods may be referred to as advertising targeting methods and systems. In response to receiving a request from a user (sender) to share a previously received advertisement with a user's contact (recipient) via a communication channel, a server implementing advertising targeting methods disclosed herein, may share the advertisement with the recipient based on various factors, including the recipient's real-time geo-location, the recipient's preferences, the recipient's communication device, the recipient's demographic information and/or the recipient's profile information and based on targeting criterion associated with the advertisement. The recipient may correspond to a contact in the user's contact database or other recipient.

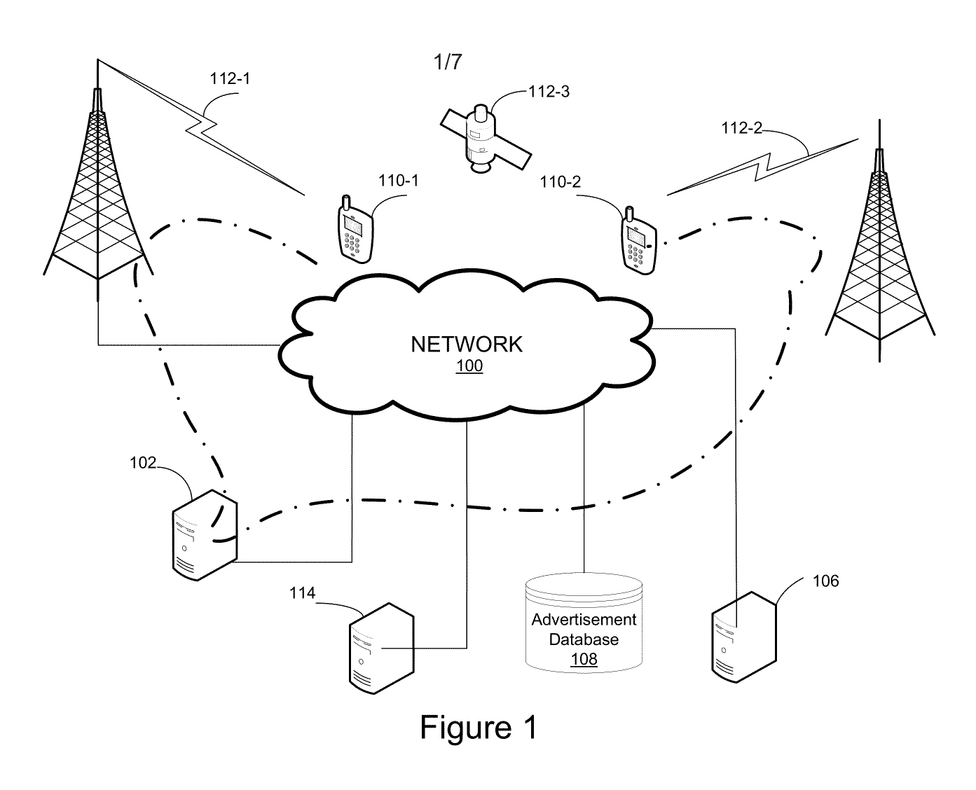

FIG. 1 depicts an example network 100 in which an exemplary advertising targeting server 102 may operate to control the delivery of advertisements. As used herein advertisements include not only offers to sell but also include any information relating to specific objects, services, social events etc. In one example, the advertising targeting server 102 operates within a server that is connected with the network. The advertisement database 108 may be utilized to store advertisers' advertisements and respective criterion associated with advertisements. The advertisement database 108 may be implemented together or separately with the advertisement targeting server 102. A third party advertiser may configure advertising targeting criterion associated with the stored advertisements so that the advertisements are targeted to potential customers of the advertisers. The advertising targeting criterion may be stored in the advertisement database 108. Advertisement targeting criterion may include demographic information of the intended target audience for the advertisement or the intended target consumers. By way of example and without limitation, the recipient's demographic or profile information may include age, gender, marital status, occupation, permanent address information, etc.

User equipment (UE) 110-1 and UE 110-2 are connected with network 100 and may be configured to receive advertisements from advertisement server 106 via network 100. The advertisement server 106 may be implemented together or separately with the advertisement targeting server 102 and/or the advertisement database 108. UE 110-1 and UE 110-2 may be operated by friends, business contacts, etc. on the network 100. In FIG. 1, UE 110-1 and 110-2 are connected with network 100 via wireless networks 112-1 and 112-2, and satellite 112-3. The wireless networks 112-1 and 112-2 and satellite 112-3 may be operated by the same or different entities. By way of example and without limitation, UE 110-1 and 110-2 are depicted as wireless devices. However, user equipment may include laptop computers, desktop computers etc. The UE 110-1 and 110-2 may execute client software applications to enable users of UE 110-1 and 110-2 to communicate with each other via network 100. Software applications may include email clients, social networking applications, text messaging applications that conform to the short messaging service (SMS) protocol, and any other proprietary messaging services including BLACKBERRY MESSENGER, GOOGLE CHAT, MSN MESSENGER, TWITTER, FACEBOOK MESSENGER, BBM CHANNELS, etc.

An application server 114 includes server hardware, software and/or firmware that enable users of UE 110-1 and 110-2 to communicate with each other via the corresponding client software application. The application server 114 can be part of a chat system and/or other communication system. The application server 114 and the advertising targeting system can be implemented together in a single server or over various servers, or they can be implemented separately over various servers. Server software executing on application server 114 may configure a communication channel via network 100 to facilitate client software executing on UE 110-1 and 110-2 to exchange information/messages with each other. Application server 114 may validate the identity of UE 110-1 and 110-2 and/or their users prior to establishing the communication channel. Validation may include requiring each of the users to “login” into their respective client software applications prior to establishing the communication channel. In this example, the communication channel used to exchange information/messages is sometimes referred to as a “chat session.” Information transmitted by UE 110-1 may be received by application server 114 via the communication channel. Application server 114 may transmit the received information to UE 110-2 via the communication channel.

In one scenario, a user operating appropriate client software application at UE 110-1 and “chatting” with a user operating UE 110-2 may cause UE 110-1 to transmit a reference to an advertisement as a part of a message, for example, via the communication channel or during the “chat session.” Additional or alternative to transmitting the reference to the advertisement, the actual advertisement could be passed. As used herein, transmitting the reference to the advertisement or transmitting the advertisement itself can mean transmitting the advertisement reference, transmitting the advertisement itself or transmitting both a reference to the advertisement and the advertisement.

In one example, the advertisement may have been previously received by UE 110-1 from advertisement server 106. Additionally or alternatively, UE 110-1 may have received the advertisement via another source such as email. Additionally or alternatively, user operating UE 110-1 may copy a hypertext link from a webpage. Generally, an advertisement may include digital content like GIF images, an audio file like a WAV file, a movie, a link to a webpage where information about the advertised product may be viewed or any combination thereof.

Application server 114 may examine the information/message received from UE 110-1 before transmitting the information to UE 110-2. Application server 114 may determine that the received message includes a reference to an advertisement. In response to determining that the received message includes a reference to an advertisement and/or advertisement, application server 114 may transmit the reference to the advertisement (e.g., advertisement identifier, hypertext link, image URL etc.) and/or advertisement to advertising targeting server 102.

Additionally or alternatively, application server 114 may transmit to advertising targeting server 102 the previously described criterion associated with UE 110-2 and/or the user of UE 110-2, and/or a reference to the criterion. Application server 114 may utilize identifier information associated with UE 110-2 to retrieve from a user database the information associated with a user who is the registered user of UE 110-2. Identifier information may include Media-Access Control (MAC) address, International Mobile Equipment Identity (IMEI) number or Electronic Serial Number (ESN) associated with UE 110-2, etc. Application server 114 may utilize validation information that user at UE 110-2 provided when the communication channel was established to retrieve from the user database the criterion associated with the user at UE 110-2.

Advertising targeting server 102 can determine if the user at UE 110-2 is within the advertiser's intended audience for the advertisement, e.g., based on the advertisement targeting criterion. If, for example, advertising targeting server 102 determines that the demographic information of the user at UE 110-2 match demographic criteria associated by the advertiser with the advertisement, advertising targeting server 102 may determine that the user at UE 110-2 is an intended audience for the advertisement. Advertising targeting server 102 may utilize the advertisement and criterion information associated with UE 110-2 received from application server 114 to determine if the advertisement, and/or reference to the advertisement, should be transmitted to UE 110-2 via the communication channel. To perform the determination, advertising targeting server 102 may retrieve criterion information associated with the advertisement from database 108, in an example.

In making a determination whether or not to transmit the advertisement to US 110-2, advertising targeting server 102 may compare the retrieved criterion information associated with the advertisement and criterion information associated with UE 110-2 or the user of UE 110-2 to determine if the user of UE 110-2 or UE 110-2 is the intended target audience for the advertisement. Additionally or alternatively, the advertising targeting server 102 may give weight to the attempt by UE 110-1 to share the advertisement with UE 110-2 and/or lessen the importance of the criterion information in making the decision about whether or not to transmit the advertisement to UE 110-2. For example, a criterion considered for transmitting the advertisement to UE 110-1 is not considered in determining whether to transmit the advertisement to UE 110-2 based on the received request from UE 110-1 to share the advertisement with the second user device. Therefore, the advertising targeting server 102 can transmit the advertisement to the intended target that may not otherwise have been determined to receive the advertisement. For example, if UE 110-1 sends a Toronto Raptors advertisement to a friend in Dallas, Tex. having UE 110-2, the advertiser's criterion for only transmitting advertisement for the Toronto Raptors to UE located in Toronto are loosened or ignored, and the Toronto Raptors advertisement is served to UE 110-2 located in Dallas, Tex.

In response to determining that the user at UE 110-2 is a valid target, advertising targeting server 102 may cause application server 114 to transmit to UE 110-2 the message received from UE 110-1 that included the reference to the advertisement and/or the advertisement itself. The application server 114 can send the reference to the advertisement and/or the advertisement itself to the recipient UE 110-2 along with the chat message or other type of message.

The UE 110-2 makes a request to the targeting server 102 to request the actual advertisement using the reference to the advertisement, the recipient's user identifier, the recipient's current device information and current location. The advertising targeting server 102 compares the received information with advertising criteria for the advertisement to determine whether or not to allow the share of the advertisement with the recipient. Criteria used to consider whether or not to transmit an advertisement to a target device or terminal can include, among other things, demographic and profile information including age, gender, ethnicity, knowledge of languages, marital status, employment status, occupation, income level, policy information permanent address information, current geographic location information of the target device or terminal, etc. Other criteria can be also used, for example, a user's interests, e.g., sports, fitness, health, finance, automotive, fashion, technology etc. The criteria can also include an influence model indicating the user's social influence or influence on purchases. Criteria can also include device information including screen size, device model number, brand and capabilities. Criteria can also include an advertisement's available inventory, etc.

The advertising targeting server 102 can deny the advertisement to the UE 110-2 based on the device information and location, user information or targeting criteria of the advertisement if a determined number of matches of the advertisement to the user device and/or user of the user device are not met. In instances where advertising targeting server 102 determines that UE 110-2 is not the intended audience for the advertisement, advertising targeting server 102 may block the advertisement from being received by UE 110-2. In the case that the advertisement is not sent, the advertising targeting server 102 can return an indication that the advertisement is no longer available, other indication or no indication of the advertisement to the recipient UE 110-2, along with the chat message or other type of message. If the advertisement is granted, the advertising targeting server 102 returns the advertisement information to the UE 110-2. The advertising targeting server 102 may return advertisement information specified for the UE 110-2 based on the device information received, including specific formatting to fit the UE 110-2, etc.

Alternatively, the application server 114 passes the reference to the advertisement and/or advertisement itself to the recipient UE 110-2 without determining whether or not sharing the advertisement with UE 110-2 is permitted. Instead, sharing is always permitted and the criterion check is only performed upon receipt of the request for the advertisement. Upon receiving the request to share the advertisement, the application server 114 passes the reference to the advertisement and/or advertisement to the recipient UE 110-2 immediately in a one-to-one chat message. This can be the same as if the targeting server 102 had indicated that the share is permitted, but in this case no check is made. The recipient UE 110-2 receives a reference to the advertisement and/or advertisement in a one-to-one chat message, and makes a request to the advertising targeting server 102 to request the actual advertisement and/or to determine whether or not to allow the share of the advertisement, using the reference to the advertisement and/or advertisement and the recipient's user identifier, including the recipient's current device information and current location. The advertising targeting server 102 checks the recipient information against the advertisement criteria to make the decision whether to allow the share of that advertisement with the recipient UE 110-2. If the advertisement is granted, the advertising targeting server 102 returns the advertising information to the recipient UE 110-2. The advertising targeting sever 102 may return advertisement information formatted for the recipient's UE 110-2 based on the device information received.

For the sake of explanation, controlling the delivery of advertisements is described herein in the context of a “chat session.” In another example, application server 114 may correspond to a text message server. In the example, a communication channel may not necessarily be established. To control delivery of advertisements in text messages received from UE 110-1 to UE 110-2 application server 114 may not only examine each text message but may also examine an identifier of the recipient associated with each text message. Based on the identifier, such as a phone number, ESN, IMEI, application server 114 may retrieve criterion associated with the recipient.

Control of the delivery of advertisement is described in the context of a single user and a single recipient. This, however, does not preclude the application of the control of the delivery of advertisements in a situation, e.g., where users are in “group chat session” or “group texts” several users. In this situation, application server 114 may receive a reference to an advertisement and/or advertisement from a sender and a list of identities of the intended recipients. Application server 114 may retrieve criterion associated with each of the intended recipients and provide each intended recipient's criterion to advertising targeting server 102. Advertising targeting server 102 may compare each recipient's criterion and the advertisement targeting criterion with the specified conditions. Advertising targeting server 102 may communicate the identities of the first set of recipients whose recipient information and advertisement targeting criterion satisfy the specified conditions. The application server 114 may transmit the reference to the advertisement and/or advertisement to this first set of recipients. The second set of recipients whose recipient information and advertisement targeting criterion do not satisfy the specified conditions may not receive the reference to the advertisement and/or advertisement. The recipients in the second set may not satisfy the conditions for different reasons.

Advertising targeting server 102, and advertisement database 108 described in the foregoing discussion may be owned or operated by a single business entity, in one scenario. In another scenario, separate business entities may own or operate advertising targeting server 102 and advertisement database 108.

By way of example and without limitation, in the foregoing discussion, application server 114, advertising targeting server 102 and advertisement server 106 are described as separate hardware components. In another scenario, functionality ascribed to advertising targeting server 102 may be implemented at advertisement server 106 or at application server 114.

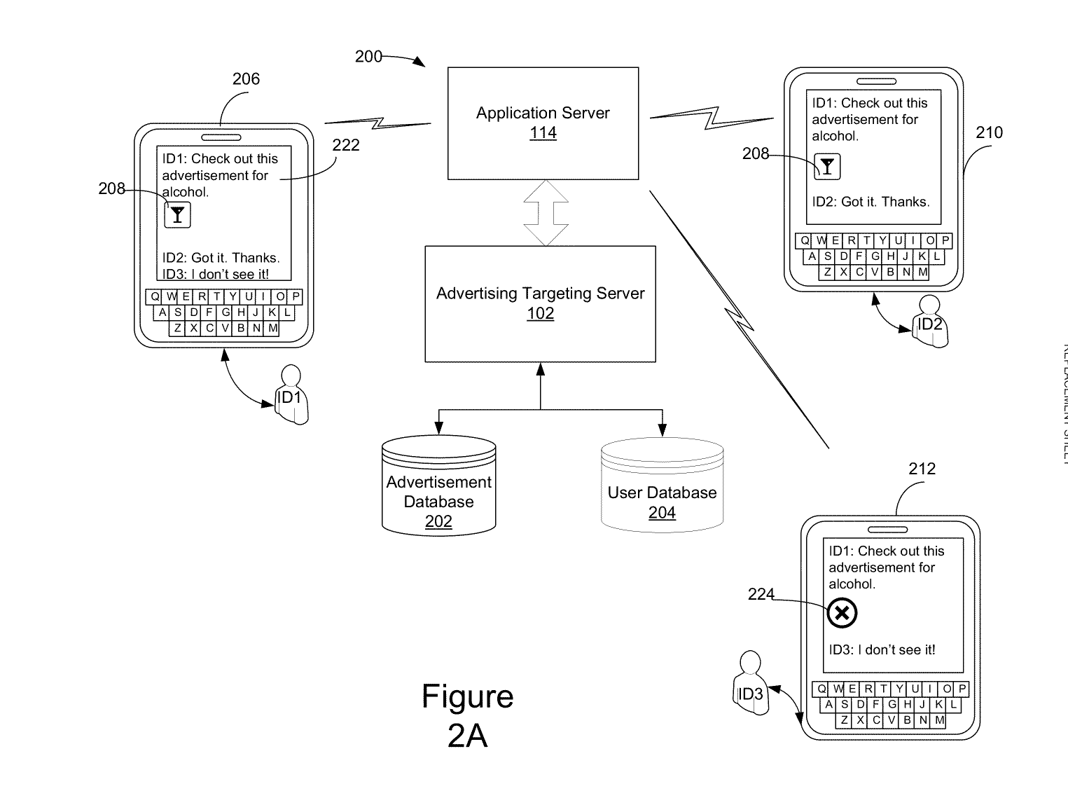

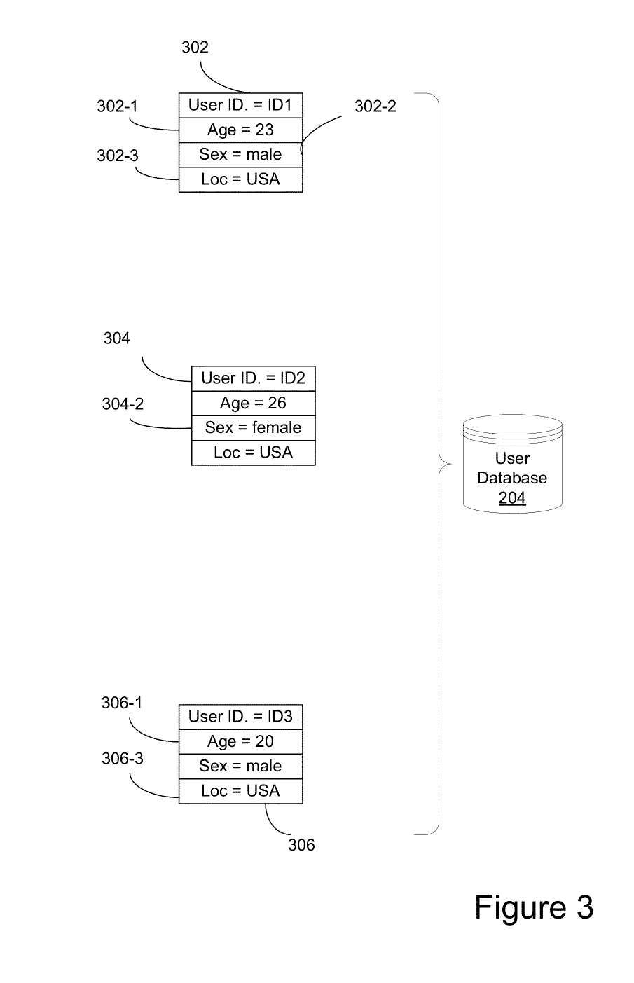

FIG. 2A is an illustration of example scenario 200 in which an advertising targeting server 102 operates to control the sharing of an advertisement 208 based on advertisement targeting criterion 402 and 404 (FIG. 4) stored in advertisement database 202 and based on recipient information stored in user database 204. Advertisement targeting criterion 402 corresponds to criterion applied for normal requests for advertisement 208. Advertisement targeting criterion 404 can correspond to criterion applied to requests for sharing advertisement 208. Advertisement targeting criterion 404 is less stringent or looser than Advertisement targeting criterion 402. For example, advertisement targeting criterion 402-2 restricts normal requests to male users whereas advertisement targeting criterion 404 imposes no such restrictions. Thus advertisement 208 may be shared with female users.

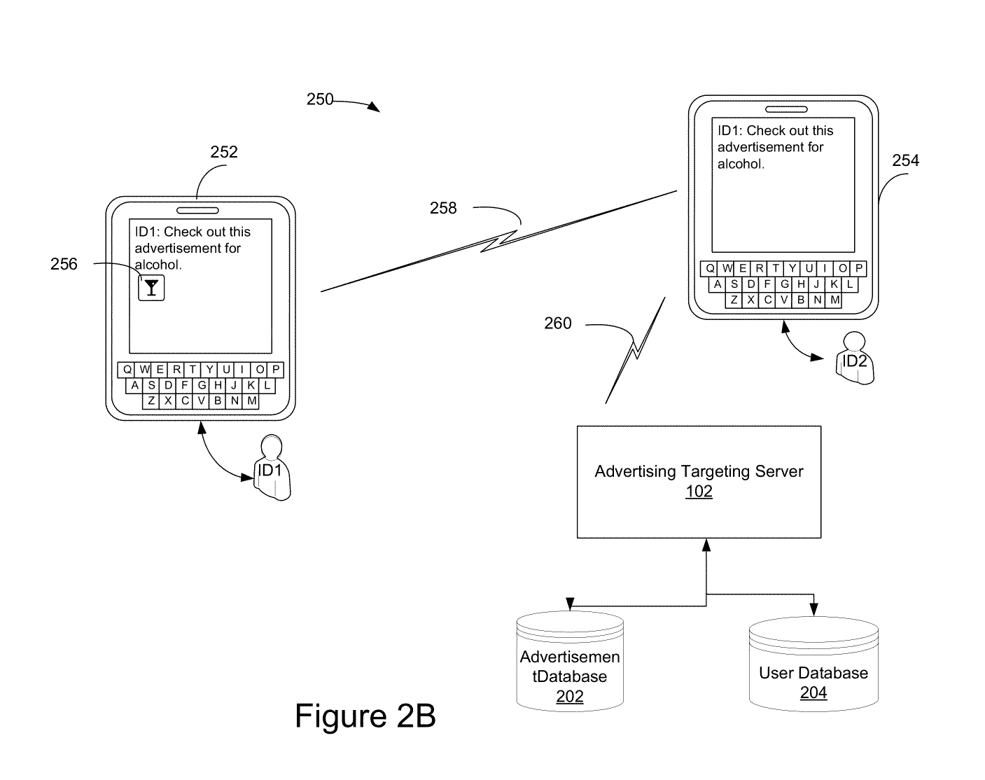

In this scenario, advertising targeting server 102 may have previously transmitted advertisement 208 to device 206, in part because user information 302 (FIG. 3) associated with user ID1 satisfied advertisement targeting criterion 402 associated with advertisement 208. In this scenario, user information 304 and 306 associated with users ID2 and ID3, respectively, do not satisfy advertisement targeting criterion 402 and consequently advertising targeting server 102 may not transmit advertisement 208 to devices 210 and 212 associated with recipients ID2 and ID3 respectively, in response to normal requests for advertisement 402. For example, user criterion 304-2 for user ID2 does not satisfy advertising targeting criterion 402. Separately, user information 306-1 and 306-3 do not satisfy global policy criterion 406 associated with advertising targeting criterion 404.

User ID1 operating device 206 may transmit a request to share with devices 210 and 212 advertisement 208 via instant message 222 that includes a reference to advertisement and/or advertisement 208. Application server 114 may receive the instant message 222 and may transmit instant message 222 including a reference to advertisement and/or advertisement 208 to devices 210 and 212. As previously discussed the instant message may be received and transmitted via communication channels or other medium that conform to a messaging protocol. In response to receiving message 222, devices 210 and 212 may transmit a request for advertisement 208.

In response to receiving the request for advertisement 208, application server 114 may instruct advertising targeting server 102 to determine if based on advertisement targeting criterion 404 and recipient information 304 and 306 if advertisement 208 should be shared with either or both users ID2 and ID3. As previously discussed, advertisement targeting criterion 404 applies to requests to share advertisement 208. The request may include a reference to user 102 and 103 and advertisement 208.

Advertising targeting server 102 may utilize the information received with the request to retrieve user information 304 and 306 from user database 204 and advertisement targeting criterion 404 from advertisement database 202. Based on user information 306-1 (age) and 306-3 (location), and/or other determined criterion, advertising targeting server 102 may determine that advertisement 208 may not be transmitted to user 103 operating device 212 because user information 306 does not satisfy the global policy 406. Generally location information 306-3 may correspond to the GPS based location of the user. Alternatively, location information 306-3 may be determined using any other means for triangulating the location of the user.

For example, the advertising targeting server 102 may enforce advertisement targeting criterion that comply with local, state and national laws. The advertising targeting server 102 may deny a request to share an advertisement for age restricted products and services with a recipient based on the recipient's demographic information. Accordingly, the advertising targeting server 102 may share an advertisement received from a sender based on determining that the age of the recipient satisfies the legal age requirement of the location where the recipient is located in addition to any other advertisement targeting criterion.

Another example of an advertisement criterion is an advertisement expiration time. If a sender transmits a request to share and advertisement after the expiration time associated with the advertisement, the advertising targeting server may not transmit the “stale” advertisement to the intended recipient although the recipient information and other advertisement targeting criterion are satisfied. In other instances, an advertiser may pre-pay the operator for a fixed number of transmissions of an advertisement (inventory e.g., 402-3, 404-2). The advertising targeting server 102 can track each time an advertisement is shared as an advertisement impression against the advertisement's available inventory. When the inventory is exhausted, requests for sharing the advertisement can be denied even though the intended recipient's criterion and the advertisement targeting criterion satisfy specified criterion associated with the advertisement.

In some instances, an advertisement may be associated with two sets of advertisement targeting criterion, one for normal advertisement requests and another for requests to share the advertisement. The advertiser may select stringent criterion for normal requests and less stringent or loose criterion for sharing requests. For example, for a normal request the advertising targeting server 102 can require geographic criteria of the advertisement to match the geographic location of the UE 110-2 to transmit the advertisement, and for a shared request the geographic criteria is ignored or discounted. Therefore, an advertisement that would not have otherwise qualified to be shared with the UE 110-2 is transmitted to the UE 110-2 by given weight to the share request. In other example, the advertising targeting server 102 may require a determined amount of advertisement criteria to match the information about the UE 110-2, and for a shared request the determined amount of matches is reduced.

To loosen the advertisement targeting criterion for requests to share an advertisement, an advertiser may exclude certain advertisement targeting criterion for requests to share that are present or enforced in the advertisement targeting criterion for normal requests. Thus, a user who may normally not be allowed to request and receive an advertisement because the user information associated with the user does not satisfy the advertisement targeting criterion for normal requests, may in some instances receive the advertisement if the advertisement is shared with the user and the user information associated with the user satisfies the advertisement targeting criterion for sharing requests. Criterion for sharing requests may include only a subset of the criterion used for normal requests. As an example, criterion for normal requests may consist of age, gender and location information for the user. Whereas criterion for sharing requests may include only of location information. Thus if the user location information satisfies the location criteria associated with the advertisement, the advertisement is shared with the user irrespective of the user's age and gender.

In this example, user ID3 is too young to receive advertisement 208 in the country where user 103 is located. Advertising targeting server 102 may indicate to application server 114 that user information associated with user 103 does not satisfy criterion associated with advertisement 208. In response, application server 114 may transmit an indication 224 to device 212 that the advertisement is not available, e.g., “Sorry, this Story is no longer Available . . . ”

Advertising targeting server 102 may determine that user information 304 satisfy the conditions imposed by advertising targeting criterion 404 and global policy criterion 406 associated with advertisement 208. In response, advertising targeting server 102 may transmit information corresponding to advertisement 208 to user ID2's device 210.

Device 210 may transmit an indication when advertisement 208 is rendered on device 210. In response, application server 114 may indicate to advertising targeting server 102 that the advertisement 208 was successfully displayed on device 210. Advertising targeting server 102 may decrement inventory counter 402-3 and 402-2.

The following are several scenarios that may illustrate the conditional sharing of advertisements by advertising targeting server 102.

In one scenario, a user A with a permanent address in a first city receives an advertisement for discounted tickets to a sports event. In this scenario, the advertisement is targeted at users with a permanent address in the first city. Consequently, location field 404-3 of advertisement targeting criterion associated with the advertisement may include an indication that restricts sharing the advertisement to users located in the first city. If the user A requests advertising targeting server 102 to share the advertisement with a contact, User B, who lives in a second city, advertising targeting server 102 would prevent user B from receiving the advertisement because location field associated with user information for user B would indicate that user B is in the second city. Data in location field of user information may be dynamically adjusted based on the geo-location of device corresponding to a user.

Referring also to FIG. 4, based on global policy structure 406 associated with an advertisement for an age restricted product like alcohol, in a second scenario, a 19 year old user A located in Canada may correctly receive an advertisement for alcohol because the location field associated with user A would indicate that user A is in Canada where the lower age limit to receive alcohol advertisement is 19. However, advertisement targeting server 102 may refuse a request to share the advertisement for alcohol with a 19 year old User B located in the United States because the location field associated with user B would indicate that user B is in the USA where the lower age limit to receive alcohol advertisement is 21. Other examples include a European user not being able to share tobacco advertisements with recipients in Canada.

In the prior discussion advertising targeting server 102 a user requests the sharing of one advertisement with one or more recipients or contacts. However, advertising targeting server 102 may also operate on messages that include references to more than one advertisement and/or one or more advertisements. In such a scenario, advertising targeting server 102 may utilize user information of the intended recipients and advertisement targeting criterion associated with each of the advertisements to determine if all, some or none of the advertisements may be shared with each of the recipients.

FIG. 2B is an illustration of another example scenario 250 in which an advertising targeting server 102 operates to control the sharing of an advertisement 208 based on advertisement targeting criterion 402 and 404 (FIG. 4) stored in advertisement database 202 and based on recipient information stored in user database 204. In this scenario, UE 252 and UE 254 may communicate directly with each other via a short range communication protocol like BLUETOOTH. In this scenario, UE 252 may transmit a digital reference to an advertisement and/or advertisement 256 to UE 254 via a communication channel 258 configured to operate in accordance with the short range communication protocol. The reference to the advertisement and/or advertisement may include one or more of a web link to the advertisement, an id of the advertisement, a pointer to the advertisement, etc. to identify the advertisement. In response to receiving the reference to the advertisement and/or advertisement, UE 254 may communicate with the advertising targeting sever 102 via communication channel 260 to determine if the advertisement may be shared with UE 254. Sharing the advertisement can include transmitting a copy of the content of the advertisement or transmitting data corresponding to or representing the advertisement to the UE 254.

In this example, the advertisement targeting server 102 may receive a request from UE 254 for the advertisement 258. The request may include the digital reference to the advertisement and/or advertisement that UE 254 received from UE 252. The advertisement targeting server 102 may determine that the reference to advertisement and/or advertisement was shared with UE 254 by UE 252. In response, the advertisement targeting server 102 may select advertisement targeting criterion from advertisement database 202. The advertisement targeting criterion associated with the advertisement may be selected based on the determining that the reference to the advertisement and/or advertisement was shared with UE 254 by UE 252. In this example, advertisement targeting server may transmit the advertisement if the criterion associated with UE 254, selected from user database 204, satisfies the criterion associated with advertisement for sharing the advertisement.

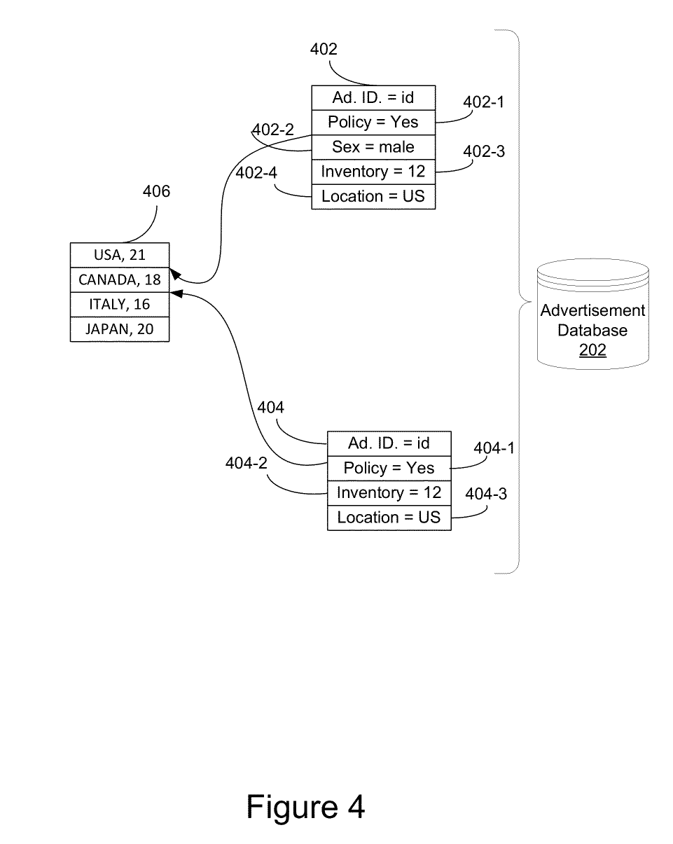

FIG. 5 is a flow diagram of an example method 500 that may be implemented to handle requests for sharing advertisements based on user information associated with the intended recipients and advertisement targeting criterion associated with the advertisements. The method 500 may use any combinations of the servers discussed above, or other systems or servers. For example, functions described for servers 102, 106, and 114 can be swapped and/or mixed. More, fewer, or different steps may be provided in the order disclosed or in another order.

For example, a sender at UE 110-1 may wish to share an advertisement with a recipient UE 110-2. The application server 114 may receive a message from a sender intended for a recipient and the message can include a reference to an advertisement and/or advertisement that the sender wishes to share with the recipient (502). When in a coverage area the message may be received via a communication channel conforming to a messaging protocol. Based on information about the intended recipient, application server 114 may establish a communication channel with the intended recipient and transmit a notification to the intended recipient, e.g., to start a chat or share a message, etc.

The application server 114 sends the share message including the reference to the advertisement and/or advertisement to the recipient UE 110-2, if allowed and applicable (504). In some implementations the reference to the advertisement and/or advertisement is not transmitted to the recipient UE 110-2. Instead, the reference to the advertisement and/or advertisement is considered by the application server 114 and/or advertising targeting server 102 for a determination of whether or not to transmit the reference to the advertisement and/or advertisement to the UE 110-2, without the reference to the advertisement and/or advertisement ever being transmitted to the recipient UE 110-2. The share message can include the sender's user identification and the advertisement information from the sender's copy of the advertisement payload. In another implementation, the recipient's user-agent information, geographic location and IP address (x-forward-for header) can be looked up based on the sender's request. The reference to the advertisement and/or advertisement may be automatically allowed or checked by the application server 114 before being allowed or blocked. The recipient UE 110-2 receives the reference to the advertisement and/or advertisement and calls the advertising targeting server 102 to request the advertisement and/or to determine whether or not to allow the share of the advertisement (506). The UE 110-2 can provide the reference to the advertisement and/or the advertisement along with the recipient's user identification.

The advertising targeting server 102 can be implemented in one or more parts. For example, a first part can include a context and analytics ad proxy server that receives the request to the advertising targeting server 102 from the recipient's UE 110-2 and looks up the recipient's information from their user identification. This can include the user's demographic information and user profile (e.g., a taste graph including the user's tastes or interests and the user's influence model) as well as their subscription information including the channels they have previously blocked. For example, advertising targeting server 102 may interrogate user database 204 by executing a structured query language (SQL) instruction that includes a reference to the identity of the intended recipient. A second part of the advertising targeting server 102 can include an ad server (e.g., by VELTI, ZEDO, MEDIAPLEX, etc.), including targeting and policy criteria for all advertisements in the system. The ad proxy looks up and sends the recipient user information to the ad server, along with the reference to the advertisement and/or advertisement, the device information and current geo-location from the request from the recipient UE 110-2. The advertising targeting server 102 retrieves the advertisement's targeting and policy criteria from the advertisement database, e.g., the advertisement database 202, corresponding to the reference to the advertisement and/or advertisement, and compares these criteria against the recipient information (508). For example, advertising targeting server 102 may interrogate advertisement database 202 by executing a structured query language (SQL) instruction that includes a reference to the advertisement and/or the advertisement. The comparison can be used to determine whether or not to share the advertisement (510).

If it is determined that the advertisement is not to be shared (512), the ad server returns a denial to the ad proxy server, which in turn returns a denial to the recipient UE 110-2 (520). The recipient's UE 110-2 can then display a denial message to the recipient. If the advertisement is to be shared (512), then the ad server retrieves information related to the advertisement in a format available to the intended recipient's UE 110-2 (514). The ad server can then transmit the advertisement to the ad proxy server for sharing with the intended recipient. The ad proxy server can send/share/transmit the advertisement to the recipient's UE 110-2 (516). The recipient's UE 110-2 can display the advertisement along with the chat or other messages to the recipient. The shared advertisement information may include images, hypertext links etc. associated with the advertisement. In response to the recipient receiving the information associated with the advertisement, advertising targeting server 102 may update previously described inventory information associated with the advertisement.

The advertising targeting server 102 can log the shared advertisement request, including advertisement share level, the sender's user identification and the recipient's user identification for reporting and advertisement termination purposes. The advertising targeting server 102 may also monitor recipient activity after an advertisement is received by the recipient (518). Recipient activity may include subsequent online commerce activity engaged in by the recipient or simply monitoring if the recipient interacts with the advertisement by clicking the advertisement for example. Results of such monitoring may be communicated to the advertiser as metrics. An advertiser may determine the success of an advertising campaign, for example, from such metrics. In some instances, an advertiser may establish revenue programs that compensate the operator of the advertising targeting server based on advertisement recipient's above described activities. The information can also be used to augment the taste graph (e.g., interest profile and influence model) for the sender and recipient, e.g., UE 110-1 and UE 110-2.

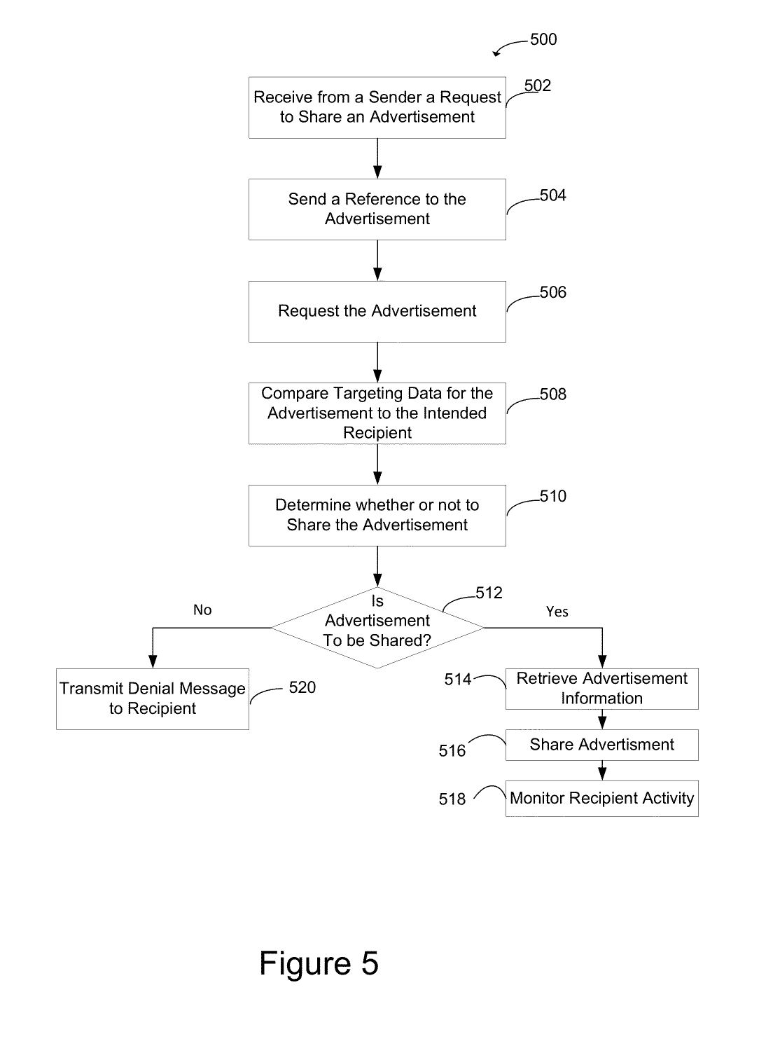

FIG. 6 illustrates user equipment 110-1 that may transmit a request to share an advertisement. The user equipment 110-1 includes one or more processors 606, one or more memory devices 608, and one or more input/output interfaces 610. The input/output interfaces 610 may be used to connect the user equipment 110-1 with other devices or networks. The processor 606 may be a computer processor implemented as a central processing unit (CPU), microprocessor, microcontroller, application specific integrated circuit (ASIC), or a combination of circuits. In one implementation, the processor 606 is a specialized microprocessor with an architecture optimized for a specific application, such as a wireless channel management application, or a specific device, such as a mobile communication device (e.g., a smartphone, tablet computer, or smart meter). The memory device 608 may include a magnetic disc, an optical disc, RAM, ROM, DRAM, SRAM, Flash and/or any other type of computer memory. The memory device 608 is communicatively coupled with the computer processor 606 so that the computer processor 606 can access data stored on the memory device 608, write data to the memory device 608, and execute programs and modules stored on the memory device 608.

The memory device 608 includes one or more data storage areas 612 and one or more programs. The data and programs are accessible to the computer processor 606 so that the computer processor 606 is particularly programmed to transmit a request to share an advertisement with UE 110-2. Furthermore, the programs and modules, or any portion of the programs and modules, may instead be implemented in hardware or circuitry.

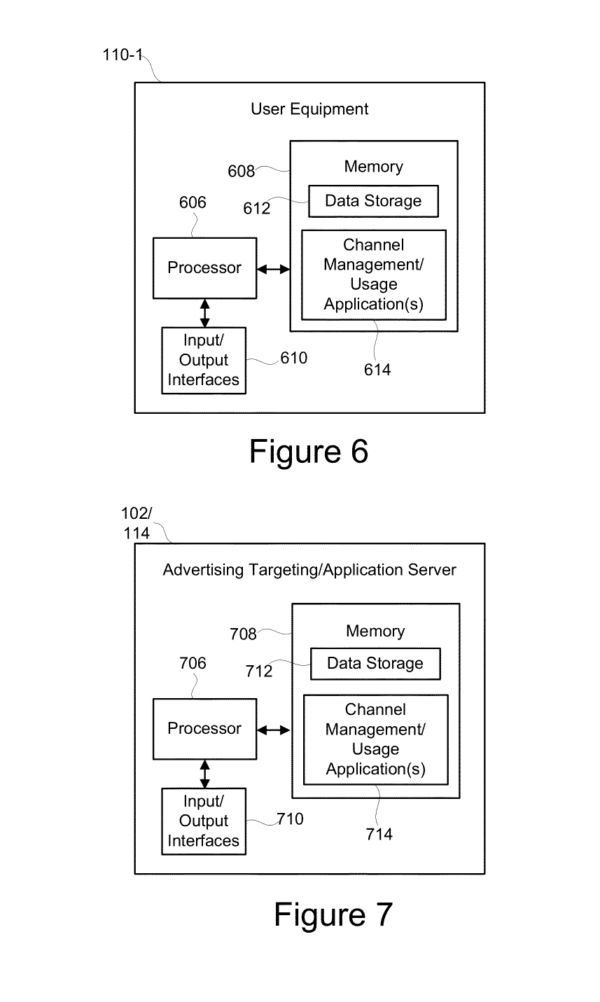

FIG. 7 illustrates an advertising targeting server 102 and/or application server 114 that responds to requests to share advertisements. Advertising targeting server 102 and/or application server 114 includes one or more processors 706, one or more memory devices 708 (including one or more data storage areas 712 and one or more programs, such as the method described with reference to FIG. 5, and one or more input/output interfaces 710. The descriptions above regarding the structure and function of components 606, 608, 610, 612, and 614 in connection with FIG. 6 are incorporated herein for the corresponding components 706, 708, 710, 712, and 714 of FIG. 7.

Each of the processes described herein may be encoded in a computer-readable storage medium (e.g., a computer memory), programmed within a device (e.g., one or more circuits or processors), or may be processed by a controller or a computer. If the processes are performed by software, the software may reside in a local or distributed memory resident to or interfaced to a storage device, a communication interface, or non-volatile or volatile memory in communication with a transmitter. The memory may include an ordered listing of executable instructions for implementing logic. Logic or any system element described may be implemented through optic circuitry, digital circuitry, through source code, through analog circuitry, or through an analog source, such as through an electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable storage medium,” “machine-readable medium,” “propagated-signal” medium, and/or “signal-bearing medium” may comprise a medium (e.g., a non-transitory medium) that stores, communicates, propagates, or transports software or data for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection having one or more wires, a portable magnetic or optical disk, a volatile memory, such as a Random Access Memory (RAM), a Read-Only Memory (ROM), an Erasable Programmable Read-Only Memory (EPROM or Flash memory), or an optical fiber. A machine-readable medium may also include a tangible medium, as the software may be electronically stored as an image or in another format (e.g., through an optical scan), then compiled, and/or interpreted or otherwise processed. The processed medium may then be stored in a computer and/or machine memory.

While various embodiments, features, and benefits of the present system have been described, it will be apparent to those of ordinary skill in the art that many more embodiments, features, and benefits are possible within the scope of the disclosure. For example, other alternate systems may include any combinations of structure and functions described above or shown in the figures.

1. A method, comprising:
transmitting by a processor an advertisement to a first user device based on a criterion for transmitting the advertisement;
receiving a request from the first user device to share the advertisement with a second user device;
transmitting a reference to the advertisement to the second user device;
receiving a request from the second user device to retrieve the advertisement related to the reference to the advertisement;
determining whether to transmit the advertisement to the second user device based on the request from the second user device and the criterion for transmitting the advertisement; and
transmitting the advertisement to the second user device based on the determination.

2. The method of claim 1, further comprising determining whether to share the advertisement with the second user before transmitting a reference to the advertisement to the second user.

3. The method of claim 2, further comprising blocking the advertisement from being received by the second user device.

4. The method of claim 1, where the transmitted advertisement would not have qualified to be transmitted to the second user device without the request from the first user device to share the advertisement.

5. The method of claim 1, where another criterion considered for transmitting the advertisement to the first user device is not considered in determining whether to transmit the advertisement to the second user device based on the received request from the first user device to share the advertisement with the second user device.

6. The method of claim 5, where the criterion comprises a current geographic location of the second user device.

7. The method of claim 1, further comprising transmitting a chat message with the reference to the advertisement.

8. The method of claim 1, further comprising communicating a message to the second user device that an advertisement is not available if the advertisement is not transmitted to the second user device.

9. The method of claim 1, where the criterion comprises policy information.

10. The method of claim 9, where the advertisement is determined not to be transmitted based on the policy information.

11. A system, comprising:
an application server to establish a communication channel between a first user terminal and a second user terminal via a communication network;
the application server to receive from the first user terminal a request to share an advertisement with the second user terminal;
the application server to transmit a reference to the advertisement to the second user terminal;
the application server to send a request to an advertising targeting server to share the advertisement related to the reference to the advertisement with the second user terminal based on a determination of whether or not the advertisement can be shared with the second user terminal; and
sharing the advertisement with the second user terminal via the communication network while the communication channel is established if it is determined that the advertisement can be shared with the second user terminal.

12. The system of claim 11, where the advertisement is shared even though a geographic location of the second user terminal is not within a geographic region of the first user terminal.

13. The system of claim 11, where a criterion transmitting the advertisement is not considered based on the request from the first user terminal to share the advertisement with the second user terminal.

14. The system of claim 11, where the advertisement is not shared with the second user terminal based on a global policy.

15. A method, comprising:
establishing a communication channel between a first user terminal and a second user terminal via a communication network;
receiving from the first user terminal a request to share an advertisement with the second user terminal;
sending a request to an advertising targeting server to share the advertisement with the second user terminal based on a determination of whether or not the advertisement can be shared with the second user terminal; and
transmitting the advertisement to the second user terminal via the communication network while the communication channel is established if it is determined that the advertisement can be shared with the second user terminal.

16. The method of claim 15, where the advertisement is shared even though a geographic location of the second user terminal is not within a geographic region of the first user terminal.

17. The method of claim 15, where a criterion for transmitting the advertisement to the first user terminal is not considered for transmitting the advertisement to the second user terminal based on the request from the first user terminal to share the advertisement with the second user terminal.

18. The method of claim 17, where the criterion comprises a current geographic location of the second user terminal.

19. The method of claim 15, further comprising transmitting a chat message with a reference to the advertisement.

20. The method of claim 15, where the advertisement is not shared with the second user terminal based on a global policy.
